(19) United States
(12) Patent Application Publication
(10) Pub. No.: US 2008/0149135 A1
(43) Pub. Date: Jun. 26, 2008

(54) WET PHOTORESIST STRIPPING PROCESS AND APPARATUS

(76) Inventors: Seon-Mee Cho, Santa Clara, CA (US); Majeed A. Foad, Sunnyvale, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 11/954,551

(22) Filed: Dec. 12, 2007

Related U.S. Application Data
(60) Provisional application No. 60/869,616, filed on Dec. 12, 2006.

(51) Int. Cl. B08B 7/04; B08B 3/08

(52) U.S. Cl. 134/4; 134/42; 134/18; 134/26

(57) ABSTRACT

A process for stripping photoresist from a substrate is provided. A processing system for implanting a dopant into a layer of a film stack, annealing the stripped film stack, and stripping the implanted film stack is also provided. When high dopant concentrations are implanted into a photoresist layer, a crust layer may form on the surface of the photoresist layer that may not be easily removed. The methods described herein are effective for removing a photoresist layer having such a crust on its surface.

### CROSS-REFERENCE TO RELATED APPLICATIONS

This application claims benefit of U.S. provisional patent application Ser. No. 60/869,616 (APPM/011727L02), filed Dec. 12, 2006, which is herein incorporated by reference.

### BACKGROUND OF THE INVENTION

1. Field of the Invention

Embodiments of the present invention generally relate to a method for stripping photoresist from a substrate and an apparatus for its practice. Embodiments of the invention also relate to a system for implanting ions and stripping photoresist.

2. Description of the Related Art

Integrated circuits may include more than one million micro-electronic field effect transistors (e.g., complementary metal-oxide-semiconductor (CMOS) field effect transistors) that are formed on a substrate (e.g., semiconductor wafer) and cooperate to perform various functions within the circuit. During circuit fabrication, a photoresist may be deposited, exposed, and developed to create a mask utilized to etch the underlying layers.

To produce the integrated circuit, it may be necessary to implant ions into various portions of the integrated circuit. During ion implantation, wafers are bombarded by a beam of electrically charged ions, called dopants. Implantation changes the properties of the material the dopants are implanted in primarily to achieve a particular electrical performance. These dopants are accelerated to an energy that will permit them to penetrate (i.e., implant) the film to the desired depth. During implantation, ions may implant in the photoresist layer and cause a hard, crust-like layer to form on the surface of the photoresist. The crust layer is difficult to remove using conventional stripping processes. Moreover, if the crust layer or underlying photoresist is not removed, the residual resist may become a contaminant during subsequent processing steps.

Therefore, a need exists for an improved method for stripping photoresist.

### SUMMARY OF THE INVENTION

The present invention generally comprises a process for stripping photoresist from a substrate. The present invention also comprises a processing system for implanting a dopant into a layer and subsequently stripping a photoresist layer. By utilizing ozonated water, sulfur containing compounds, and/or chlorine containing compounds, a photoresist and layer, including implanted photoresist, may be effectively stripped from the substrate. Annealing may then occur. By providing the implantation, stripping, and annealing within the same processing system, oxidation may be reduced and substrate throughput may be increased. The substrate throughput may be increased because a portion of the dopant may remain in the implantation chamber and be used during the implantation of the next photoresist. The portion of the dopant that remains in the implantation chamber reduces the amount of time necessary to perform the implantation for the next substrate.

In one embodiment, photoresist stripping method is disclosed. The method comprises positioning a substrate having a photoresist layer thereon in a chamber, exposing the photoresist layer to an aqueous stripping solution comprising at least one of ozonated water, sulfur containing solution, chlorine containing solution, and combinations thereof, and stripping the photoresist from the substrate in the presence of the aqueous solution.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a sectional view of a stripping chamber according to one embodiment of the invention.

FIG. 2 is a cross-sectional view of a structure having a crusted layer formed thereon.

FIG. 3 is flow diagram of a stripping process according to one embodiment of the invention.

FIGS. 4A and 4B are schematic plan views of processing systems according to the invention.

FIGS. 5A and 5B are flow diagrams for different processes that may be performed in the systems of FIGS. 4A and 4B according to the invention.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

The present invention generally comprises a process for stripping photoresist from a film stack disposed over a substrate. The present invention also comprises a processing system for implanting a dopant into a layer of a film stack, and subsequently stripping a photoresist layer disposed on the film stack. When high dopant concentrations are implanted into the photoresist, a crust layer may form on the photoresist layer. The crust layer may form due to the photoresist losing hydrogen during the implantation. The loss of hydrogen from the surface of the photoresist layer promotes carbon bonding that creates a hard, graphite-like crust. The photoresist, including the crust, may be effectively stripped from the substrate using ozonated water, sulfur containing compounds, and/or chlorine containing compounds. The stripped film stack may then be annealed. By providing the implantation, stripping, and annealing within a single processing system, oxidation of the film stack may be avoided while providing a high substrate throughput. The substrate throughput may be increased because a portion of the dopant may remain in the implantation chamber and be used during the implantation of the next photoresist. The portion of the dopant that remains in the implantation chamber reduces the amount of time necessary to perform the implantation for the next substrate.

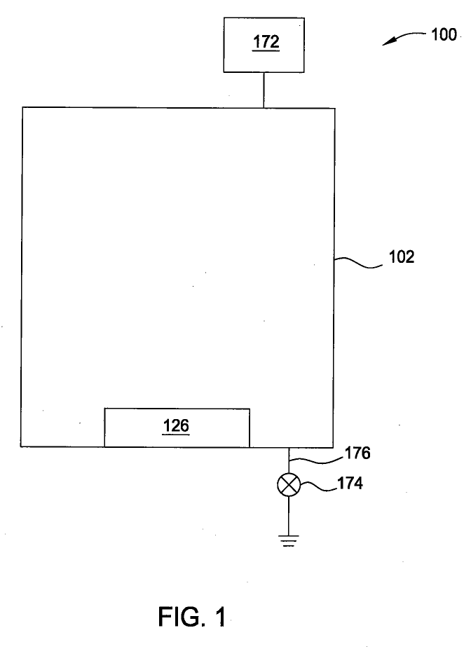

FIG. 1 is a sectional view of a stripping chamber 100 according to one embodiment of the invention. The stripping chamber 100 includes a chamber body 102. A substrate 126 may be positioned in the processing chamber 102. Aqueous solution may be fed from an aqueous solution source 172 into the processing chamber 102. A valve 174 may be opened to allow the aqueous solution to exit the processing chamber 102 through an exit port 176. A wet etching chamber, available from Applied Materials, Inc. of Santa Clara, Calif., may be adapted to perform the wet stripping process, among other chambers, including those from other manufacturers.

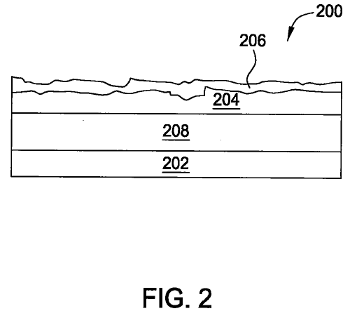

FIG. 2 is a cross-sectional view of a workpiece 200 having a substrate 202, film stack 208, and photoresist layer 204 thereon. The film stack 208, while generically shown, refers to one or more layers that may be present between the substrate 202 and the photoresist layer 204. The photoresist layer 204 may have a crusted portion 206. The crusted portion 206 may be formed on the photoresist layer 204 as a result of the photoresist layer 204 being exposed to a dopant such as phosphorus, arsenic, or boron during the implantation process.

The implantation process may cause the surface of the photoresist to lose hydrogen. Because hydrogen is lost, carbon-carbon bonds form and result in a thick carbonized crust layer. For very high doses of dopant (i.e., about 1×10¹⁵) and relatively low energy implantation, the crust layer may contain a high concentration of dopant. In one embodiment, the dopant may comprise boron. In another embodiment, the dopant may comprise arsenic. In yet another embodiment, the dopant may comprise phosphorus. The standard photoresist representation and crust layer representation are shown below.

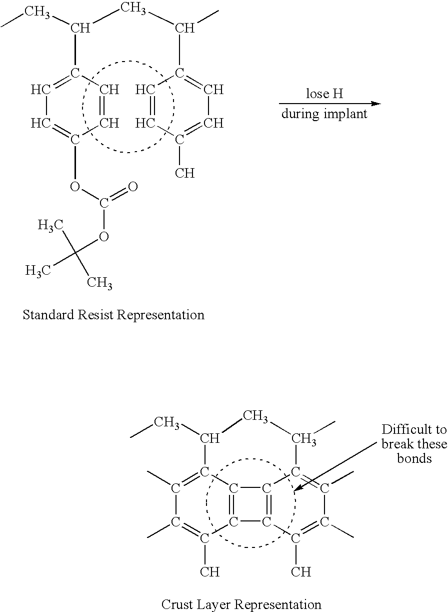

Because the crust layer comprises a dopant such as boron, phosphorus, or arsenic, removal by a conventional stripping method comprising oxygen may not be sufficient to effectively remove the crust layer 206 and the photoresist layer 204.

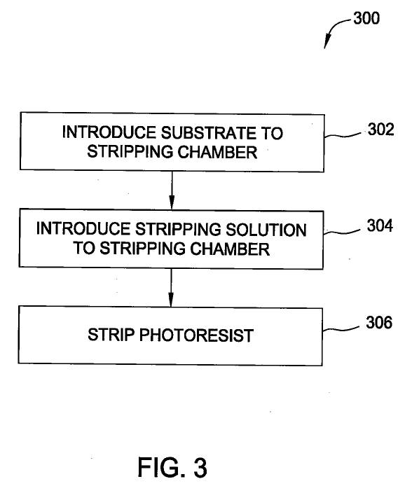

FIG. 3 is flow diagram of the stripping process 300 according to one embodiment of the invention. The process 300 begins at step 302 by introducing the workpiece 200 into the chamber 100. At step 304, a stripping solution is introduced to the stripping chamber 100. The photoresist layer 204, including any crust layer 206 if present, is removed from the workpiece 200 by the stripping solution at step 306.

During the stripping process 300, the following chemical reactions occur:

—CH₂+3O₃→3O₂+CO₂+H₂O

—CH₂+2OH→CO₂+2H₂

The stripping solution may include ozonated water, sulfur containing solutions, chlorine containing solutions, and combinations thereof. In one embodiment, fluorine containing solutions may additionally or alternatively be used. The temperature for the workpiece 200 may be set between about 90 degrees Celsius and about 100 degrees Celsius. In one embodiment, the temperature of the workpiece 200 may be above 90 degrees Celsius. In one embodiment, the solutions are aqueous (i.e., contain water). When the solutions contain water, the temperature of the workpiece 200 may remain below the boiling point of water to ensure that the water does not evaporate. In another embodiment, the solutions may be non-aqueous. In one embodiment, the stripping solution may be acidic. In another embodiment, the stripping solution may be basic.

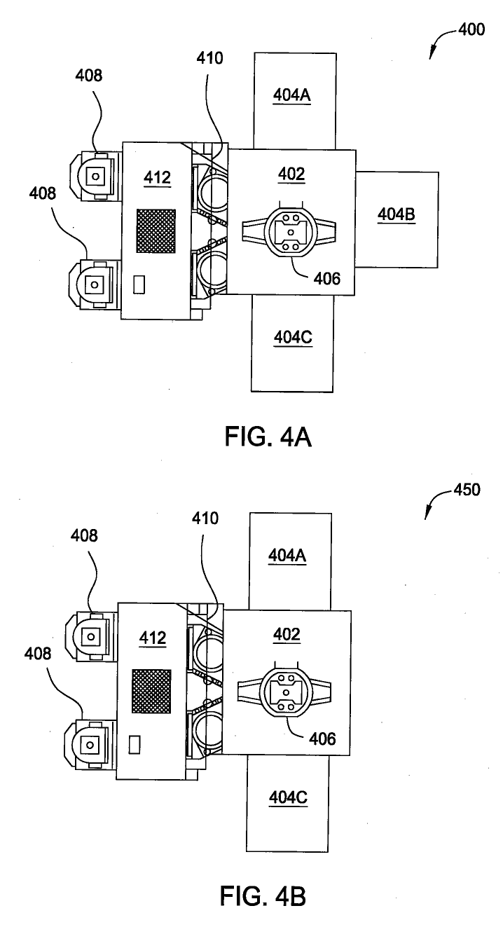

FIGS. 4A and 4B are schematic plan views of processing systems 400, 450 according to the invention. In the embodiment shown in FIG. 4A, a processing system 400 includes a central transfer chamber 402 surrounded by three processing chambers 404A-C. A factory interface 412 is coupled to the transfer chamber 402 by a load lock chamber 410. One or more FOUP's 408 are disposed in the factory interface 412 for substrate storage. A robot 406 is positioned in the central transfer chamber 402 to facilitate substrate transfer between processing chambers 404A-C and the load lock chamber 410. The substrate may be provided to the processing chambers 404A-C of the system 400 from the FOUP 408 through a load lock chamber 410 and removed from the system 400 through the load lock chamber 410 to the FOUP 408.

Each of the processing chambers 404A-B are configured to perform a different step in processing of the substrate. For example, processing chamber 404A is an implantation chamber for implanting dopants into the workpiece. An exemplary implantation chamber is a P3i® chamber, available from Applied Materials, Inc. of Santa Clara, Calif., which is discussed in U.S. patent application Ser. No. 11/608,357, filed Dec. 8, 2006, which is incorporated by reference in its entirety. It is contemplated that other suitable implantation chambers, including those produced by other manufacturers, may be utilized as well.

The chamber 404B is configured as a stripping chamber and is utilized to strip the photoresist and the crust layer from the workpiece. An exemplary stripping chamber 404B is described as the reactor 100 in FIG. 1. Suitable wet stripping chambers are also available from Applied Materials, Inc. It is contemplated that other suitable implantation chambers, including those produced by other manufacturers, may be utilized as well.

The processing chamber 404C is an annealing chamber that is utilized to anneal the workpiece after stripping. An exemplary annealing chamber that may be used is a Radiance® rapid thermal processing chamber, available from Applied Materials, Inc, which is discussed in U.S. Pat. No. 7,018,941 which is incorporated by reference in its entirety. It is contemplated that other suitable implantation chambers, including those produced by other manufacturers, may be utilized as well.

By providing the implantation, stripping, and annealing chambers on a single processing tool, substrate throughput may be increased. The substrate may be processed by first implanting the dopant into the substrate. Then, the photoresist may be stripped from the implanted substrate. Finally, the stripped substrate may be annealed.

FIG. 4B shows another processing system 450 according to the invention in which at least two processing chambers 404A and 404C are present. The processing chamber 404A is an implantation chamber while the chamber 404C is an annealing chamber. The stripping chamber 404B may be coupled with the processing system 450 on the atmospheric side of the load lock chamber 410, for example, to the factory interface 412. In another embodiment, the stripping chamber 404B may be outside the system 450, for example, in another tool.

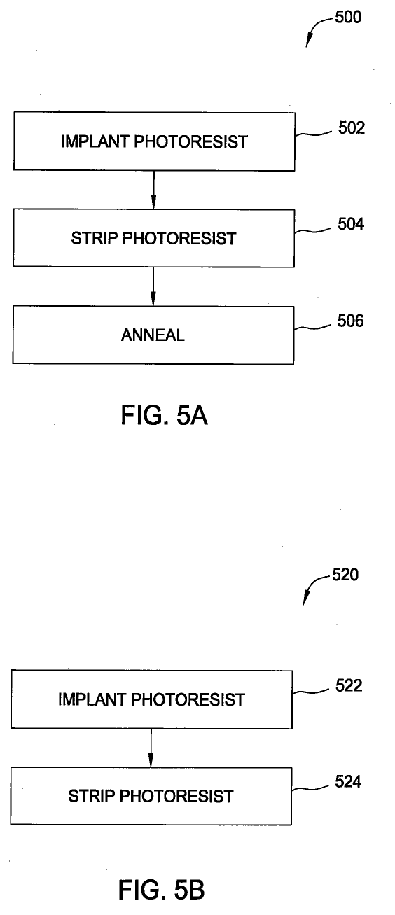

FIGS. 5A and 5B are flow diagrams of the process of producing the photoresist according to the invention. FIG. 5B shows a flow diagram 500 in which the substrate is initially implanted with a dopant (Step 502), the photoresist is stripped (Step 504), and the substrate annealed (Step 506). Flow diagram 500 corresponds to FIG. 4A where an implantation chamber, a stripping chamber, and an annealing chamber are all present on the same apparatus.

FIG. 5A shows a flow chart 520 in which the photoresist is initially implanted with a dopant (Step 522) and then stripped (Step 524). Flow chart 520 corresponds to FIG. 4B where the photoresist is stripped and implanted on the same apparatus.

In another embodiment, a two part stripping process may be used. In the two part stripping process, a dry stripping process may occur and then a wet stripping process may occur as discussed above. The dry stripping process may comprise exposing the photoresist to one or more of water vapor, hydrogen, fluorine, and oxygen as discussed in U.S. Provisional Patent Application No. 60/869,554, filed Dec. 11, 2006, which is hereby incorporated by reference. Alternatively, the wet stripping may occur first to aggressively remove the crust layer and then the dry stripping process may occur. The conditions for both the wet stripping and the dry stripping may be optimized to assure efficient and effective photoresist stripping.

By utilizing ozonated water, sulfur containing solutions, chlorine containing solutions, and fluorine containing solutions, photoresist and a crust layer formed thereon may be stripped from the substrate effectively and efficiently.

While the foregoing is directed to embodiments of the present invention, other and further embodiments of the invention may be devised without departing from the basic scope thereof, and the scope thereof is determined by the claims that follow.

1. A photoresist stripping method, comprising:
positioning a substrate having a photoresist layer thereon in a stripping chamber;
exposing the photoresist layer to an aqueous stripping solution comprising at least one of ozonated water, sulfur containing solution, chlorine containing solution, and combinations thereof; and
stripping the photoresist from the substrate in the presence of the aqueous solution.

2. The method of claim 1, wherein the photoresist layer is exposed to an implanting process prior to stripping.

3. The method of claim 1, further comprising:
annealing the substrate after the stripping the photoresist.

4. The method of claim 1, further comprising:
disposing the substrate into an implantation chamber;
implanting ions into a layer disposed between the substrate and the photoresist layer while forming a crust layer on the photoresist;
transferring the substrate from the implantation chamber;
transferring the substrate from the stripping chamber and into an annealing chamber; and
annealing the substrate.

5. The method of claim 4, wherein the ions are selected from the group consisting of boron, phosphorus, arsenic, and combinations thereof.

6. The method of claim 4, wherein the crust layer comprises two aromatic rings bonded together by two single carbon-carbon bonds.

7. The method of claim 1, wherein the stripping comprises converting the photoresist into diatomic oxygen, carbon dioxide, water, and diatomic hydrogen.

8. The method of claim 1, wherein the stripping comprises biasing the substrate with an RF current.

9. The method of claim 1, wherein the substrate is maintained at a temperature above about 90 degrees Celsius.

10. The method of claim 9, wherein the substrate is maintained at a temperature between about 90 degrees Celsius and about 100 degrees Celsius.

11. The method of claim 1, wherein the aqueous solution comprises an acid.

12. A photoresist stripping method, comprising:
disposing a substrate into processing chamber, the substrate having a photoresist layer thereon;
implanting one or more ions into a layer disposed between the photoresist layer and the substrate, the implanting forming a crust layer out of at least a portion of the photoresist layer;
exposing the crust layer to an aqueous stripping solution comprising at least one of ozonated water, sulfur containing solution, chlorine containing solution, and combinations thereof; and
removing the crust layer and the photoresist layer.

13. The method of claim 12, wherein the crust layer comprises two aromatic rings bonded together by two single carbon-carbon bonds.

14. The method of claim 12, wherein the implanted ions comprise boron.

15. The method of claim 12, wherein the substrate is maintained at a temperature above about 90 degrees Celsius.

16. The method of claim 15, wherein the substrate is maintained at a temperature between about 90 degrees Celsius and about 100 degrees Celsius.

17. The method of claim 11, wherein the aqueous solution comprises an acid.

18. The method of claim 11, wherein the ions are selected from the group consisting of boron, phosphorus, arsenic, and combinations thereof.

19. The method of claim 11, wherein the stripping comprises converting the photoresist into diatomic oxygen, carbon dioxide, water, and diatomic hydrogen.

20. The method of claim 11, further comprising annealing the substrate.
